(19) United States
(12) Patent Application Publication
(10) Pub. No.: US 2014/0241714 A1
(43) Pub. Date: Aug. 28, 2014

(54) PROTOCOL SYSTEM AND RELATED METHOD OF AUTOMATICALLY SWITCHING CONNECTION

(71) Applicant: PIXART IMAGING INC., Hsin-Chu City (TW)

(72) Inventors: Chun-Wei Chen, Hsin-Chu City (TW); Ren-Hau Gu, Hsin-Chu City (TW)

(73) Assignee: PixArt Imaging Inc., Hsin-Chu City (TW)

(21) Appl. No.: 13/888,383

(22) Filed: May 7, 2013

(30) Foreign Application Priority Data
Feb. 22, 2013 (TW) 102106284

(51) Int. Cl. G06F 3/03; H04B 7/26

(52) U.S. Cl. CPC G06F 3/0304; H04B 7/26
USPC 398/38; 455/39; 455/68

(57) ABSTRACT

A method of automatically switching connection is disclosed in the present invention. The method is applied to connection setting between a signal transmission device and at least one signal transceiver device. The method includes outputting a detecting signal to search the signal transceiver device within an effective range of the detecting signal, receiving a reacting signal generated according to the detecting signal, analyzing the detecting signal wherein the detecting signal represents a distance between the signal transmission device and the signal transceiver device, and switching the connection setting of the signal transmission device when the distance is smaller than a threshold, so that the signal transmission device can be matched with the signal transceiver device.

### BACKGROUND OF THE INVENTION

1. Field of the Invention

The present invention relates to a protocol system and a related method of switching connection, and more particularly, to a protocol system and a related method of automatically switching connection.

2. Description of the Prior Art

A conventional wireless mouse has a matched wireless transceiver disposed on the computer host. The wireless mouse can transmit coordinates to the computer host via the wireless transceiver as the wireless mouse is within a sensing range of the wireless transceiver, so as to drive the computer host to execute corresponding application program. However, the conventional wireless mouse is matched with the corresponding wireless transceiver and the related computer host after the connection is set, the user manually resets the connection of the wireless mouse relative to the wireless transceiver disposed on the other computer host as intending to use the wireless mouse to control the other computer host, which results inconvenience. Thus, design of the wireless mouse capable of rapidly switching connection between the different wireless transceivers and the related computer host is an important issue in the computer industry.

### SUMMARY OF THE INVENTION

The present invention provides a protocol system and a related method of automatically switching connection for solving above drawbacks.

According to the claimed invention, a method of automatically switching connection is disclosed. The method is applied to connection setting between a signal transmission device and at least one signal transceiver device. The method includes outputting a detecting signal to search the signal transceiver device within an effective range of the detecting signal, receiving a reacting signal generated according to the detecting signal, analyzing the reacting signal wherein the reacting signal represents a distance between the signal transmission device and the signal transceiver device, and switching the connection setting of the signal transmission device when the distance is smaller than a threshold, so that the signal transmission device is matched with the signal transceiver device.

According to the claimed invention, the method further includes detecting coordinates of the signal transmission device, and transmitting the coordinates to the signal transceiver device via the connection.

According to the claimed invention, a method of automatically switching connection is disclosed. The method is applied to connection setting of a signal transceiver device relative to a signal transmission device. The method includes receiving a detecting signal, outputting a reacting signal generated according to the detecting signal, and receiving a control command to establish connection between the signal transmission device and the signal transceiver device.

According to the claimed invention, the method further includes receiving coordinates of the signal transmission device via the connection, and transmitting the coordinates to a host.

According to the claimed invention, a protocol system capable of automatically switching connection is disclosed. The protocol system includes at least one signal transceiver device and a signal transmission device. The signal transceiver device includes an actuating unit and a first wireless transmission unit. The actuating unit is for generating a reacting signal. The signal transmission device includes a second wireless transmission unit, a detecting unit and a processing unit. The detecting unit is for outputting a detecting signal and receiving the reacting signal generated by the actuating unit according to the detecting signal. The processing unit is electrically connected to the second wireless transmission unit and the detecting unit. The processing unit receives and analyzes the reacting signal to acquire a distance between the signal transmission device and the signal transceiver device when the detecting signal detects the signal transceiver device, and switches connection setting of the second wireless transmission unit when the distance is smaller than a threshold, so that the first wireless transmission unit is matched with the second wireless transmission unit. The reacting signal represents the distance between the signal transmission device and the signal transceiver device.

The signal transceiver device and the signal transmission device can respectively be the wireless signal transceiver (dongle) and the wireless mouse. When the wireless mouse moves from one host to the other host, the connecting setting of the wireless mouse is unnecessary to manually reset and the wireless signal transceiver is unnecessary to remove, the wireless mouse applied to the protocol system of the present invention can actively search the nearest wireless signal transceiver within the effective range for automatically switching the connection. The present invention can simplify the conventional connecting procedures, which means the conventional method for switching the connection, such as a manual actuation or reset of the signal transmission device, is replaced by the present invention. Therefore, the protocol system of the present invention can automatically and rapidly switch the connection between the different devices, so as to increase the operational convenience and market competition of the product.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a protocol system according to an embodiment of the present invention.

FIG. 2 is a functional block diagram of a signal transceiver device and a signal transmission device according to the embodiment of the present invention.

FIG. 3 is a flow chart of automatically switching connection of the signal transmission device according to the embodiment of the present invention.

FIG. 4 is a flow chart of automatically switching connection of the signal transceiver device according to the embodiment of the present invention.

### DETAILED DESCRIPTION

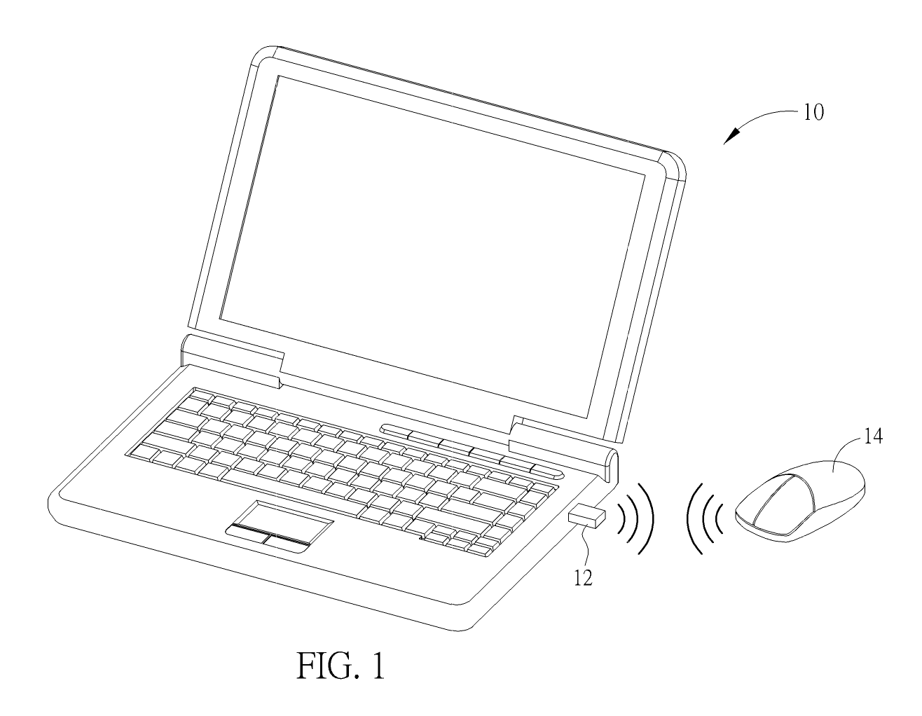

Please refer to FIG. 1. FIG. 1 is a diagram of a protocol system 10 according to an embodiment of the present invention. The protocol system 10 includes at least one signal transceiver device 12 and a signal transmission device 14. The signal transmission device 14 can detect a distance between the two devices, to search one signal transceiver device 12 that is mostly close to the signal transmission device 14 for automatically setting connection. Therefore, when utilizing the signal transmission device 14 to control different signal transceiver devices 12, the user does not manually reset the connection. The connection between the signal transceiver device 12 and the signal transmission device 14 can be set automatically according to user's demand, so as to effectively increase operational convenience of the protocol system 10. For example, the signal transmission device 14 can be a wireless inputting device, such as the wireless mouse or the wireless keyboard. The signal transceiver device 12 can be a wireless signal transceiver disposed on a host for receiving a wireless signal outputted from the signal transmission device 14 and transmitting the wireless signal to the host.

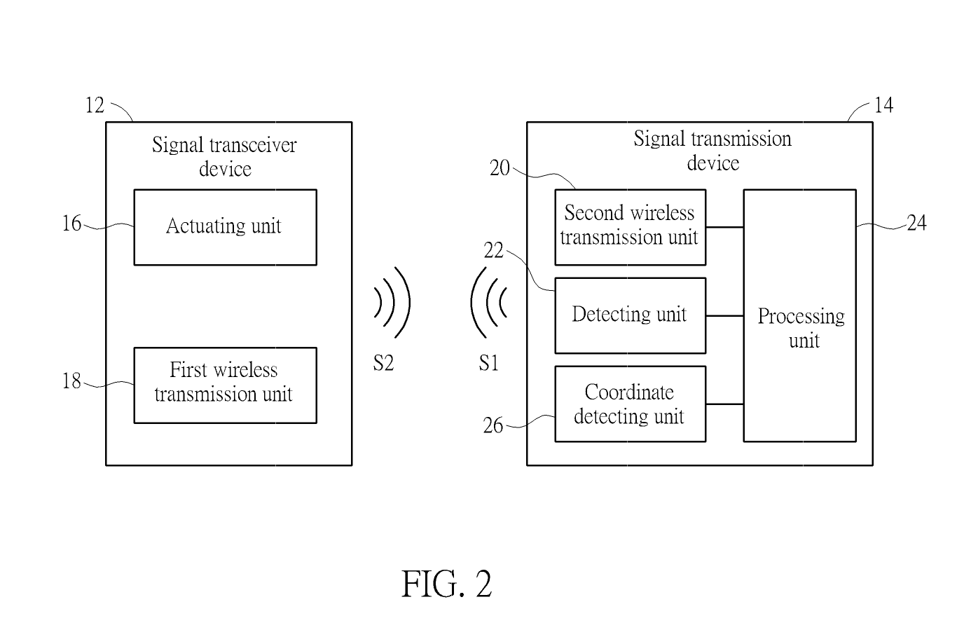

Please refer to FIG. 1 and FIG. 2. FIG. 2 is a functional block diagram of the signal transceiver device 12 and the signal transmission device 14 according to the embodiment of the present invention. The signal transceiver device 12 includes an actuating unit 16 and a first wireless transmission unit 18. The signal transmission device 14 includes a second wireless transmission unit 20, a detecting unit 22 and a processing unit 24. The processing unit 24 is electrically connected to the second wireless transmission unit 20 and the detecting unit 22. As automatically setting the connection, the detecting unit 22 outputs a detecting signal S1 according to a predetermined period for searching the signal transceiver device 12 within an effective range of the detecting signal S1. The signal transceiver device 12 within the effective range can utilize the actuating unit 16 to generate a corresponding reacting signal S2 according to property of the detecting signal S1. An intensity of the reacting signal S2 represents a distance variation between the signal transmission device 14 and the signal transceiver device 12. When the detecting unit 22 detects the reacting signal S2, the processing unit 24 can analyze value of the reacting signal S2 to acquire the distance between the signal transmission device 14 and the signal transceiver device 12. The processing unit 24 further compares the distance to a predetermined threshold, so as to determine whether the connection of the first wireless transmission unit 18 and the second wireless transmission unit 20 is actuated for matching.

As the protocol system 10 includes a plurality of signal transceiver devices 12, the detecting unit 22 of the signal transmission device 14 receives a plurality of reacting signals S2, and the processing unit 24 selects one of the reacting signals S2 with great value. Generally, the intensity of the reacting signal S2 is inversely proportional to the distance between the signal transmission device 14 and the signal transceiver device 12. The value of the intensity of the reacting signal S2 is greater, the distance between n the signal transmission device 14 and the signal transceiver device 12 is closer. Thus, the processing unit 24 can rapidly select one signal transceiver device 12 that is mostly close to the signal transmission device 14, and establish the connection between the wireless transmission units when the distance is smaller than the threshold. When the user holds the signal transmission device 14 (the wireless inputting device) of the present invention to move among the plurality of signal transceiver devices 12 (the wireless signal transceiver), the signal transmission device 14 can select the nearest signal transceiver device 12, and automatically switch connection to match with the selected signal transceiver device 12.

The protocol system 10 of the present invention utilizes near field communication (NFC) function to detect the close distance between the signal transceiver device 12 and the signal transmission device 14. According to the different NFC functions, the actuating unit 16 can selectively be a conductive wire, a reflective component with reflective property, or an electric wave follower. For example, when the actuating unit 16 is the reflective component, the detecting unit 22 can output the optical detecting signal S1 (or the other electromagnetic signal). The actuating unit 16 reflects the optical detecting signal S1 to generate the reacting signal S2, which is received by the detecting unit 22. As the signal transmission device 14 moves close to the signal transceiver device 12, a reflecting energy intensity of the reacting signal S2 makes stronger, so the processing unit 24 can analyze the value of the reacting signal S2 to acquire the corresponding distance, for determining whether the connection setting between the first wireless transmission unit 18 and the second wireless transmission unit 20 is automatically executed.

The actuating unit 16 and the detecting unit 22 can further be the conductive wires, which have own electromagnetic fields. When the distance between the signal transmission device 14 and the signal transceiver device 12 is smaller than the threshold, the electromagnetic fields are coupled due to the adjacent conductive wires for varying an electromagnetic flux of the reacting signal S2. The processing unit 24 can select the nearest signal transceiver device 12 relative to the signal transmission device 14 according to variation of the electromagnetic flux for automatically switching the connection. Besides, the actuating unit 16 can further be the electric wave follower, and the detecting unit 22 can be a radiofrequency identification label, which transmits the signal via the electromagnetic filed with radio frequency. When the radiofrequency identification label receives an outputting signal from the electric wave follower within its detecting range, the electric wave follower can transmit energy to the radiofrequency identification label via the reacting signal S2, so as to drive the radiofrequency identification label to output a control command for setting the connection. Further, the radiofrequency identification label can have own power source. The radiofrequency identification label can actively output the control command for setting the connection. Application of the actuating unit 16 is not limited to the above-mentioned embodiments, and depends on design demand.

In the preferred embodiment of the present invention, the signal transmission device 14 can be the wireless inputting device, such as the wireless mouse. The signal transmission device 14 can further include a coordinate detecting unit 26 electrically connected to the processing unit 24, as shown in FIG. 2. When the signal transmission device 14 moves away from one of the signal transceiver devices 12, the connection between the second wireless transmission unit 20 of the signal transmission device 14 and the first wireless transmission unit 18 of the signal transceiver device 12 is interrupted. When the signal transmission device 14 moves within the detecting range of the other signal transceiver device 12, the signal transmission device 14 can automatically establish the connection with the signal transceiver device 12 when determining the distance between the signal transmission device 14 and the matched signal transceiver device 12 is smaller than the threshold. It is to say, the user does not switch the connection manually. The wireless mouse (the signal transmission device 14) can freely move among the hosts that dispose the corresponding wireless signal transceivers (the signal transceiver device 12). With a movement of the wireless mouse (the signal transmission device 14), the wireless mouse can automatically establish the connection with the nearest wireless signal transceiver, so as to transmit coordinates detected by the coordinate detecting unit 26 to the matched wireless signal transceiver (the signal transceiver device 12) for controlling the corresponding host.

The protocol system 10 of the present invention further can be applied to the other situation. For example, the signal transceiver device 12 and the signal transmission device 14 can be portable electronic devices with wireless transmission function, such as a personal digital assistance, a smart phone or a tablet computer. As actuating the automatic connecting function of the portable electronic device, each portable electronic device can establish the connection with the other nearest portable electronic device, so the portable electronic device with functions of the automatically switching connection of the present invention can have preferred operational convenience. Application of the protocol system 10 of the present invention is not limited to the above-mentioned embodiments, which depends on actual demand, and a detailed description is omitted herein for simplicity.

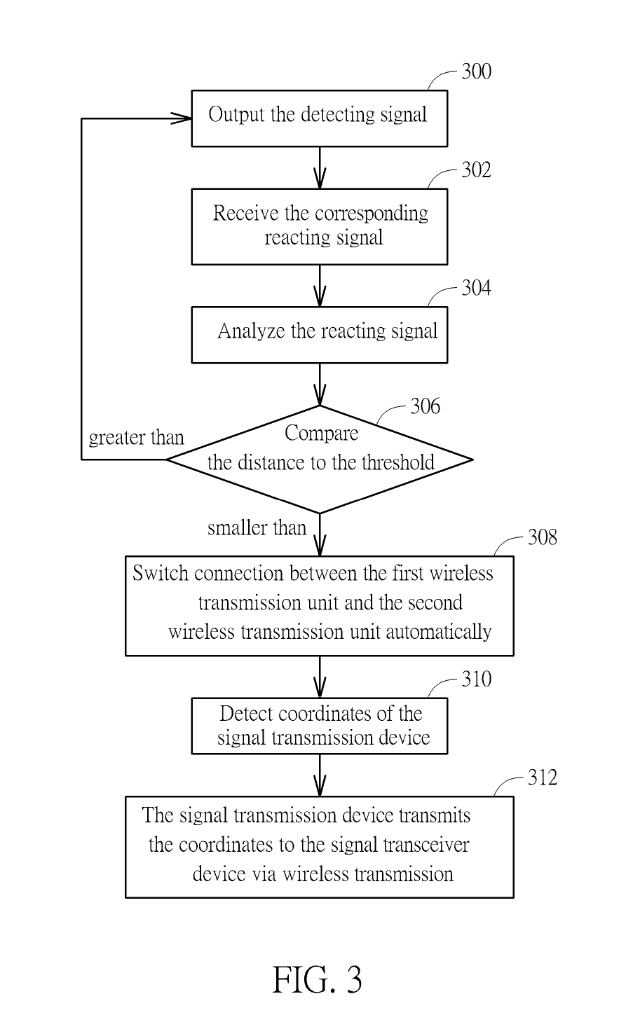

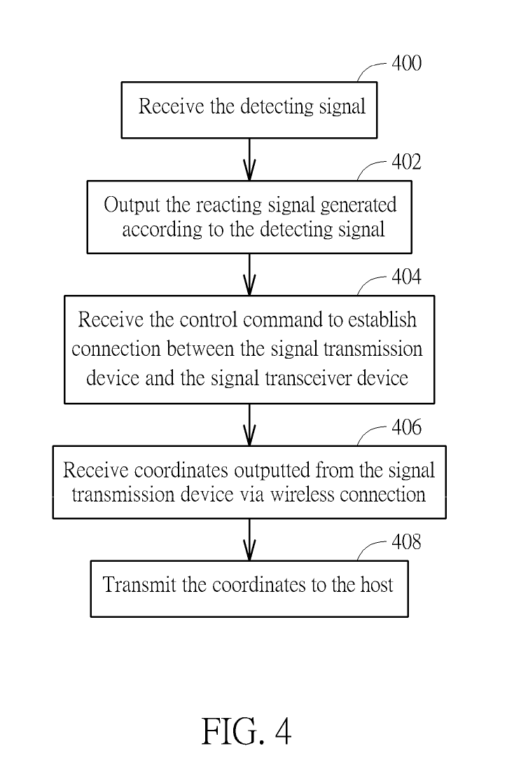

Please refer to FIG. 3 and FIG. 4. FIG. 3 is a flow chart of automatically switching connection of the signal transmission device 14 according to the embodiment of the present invention. FIG. 4 is a flow chart of automatically switching connection of the signal transceiver device 12 according to the embodiment of the present invention. First, steps 300 and 302 are executed by the signal transmission device 14: the detecting unit 22 outputs the detecting signal S1, and receives the corresponding reacting signal S2. The intensity of the reacting signal S2 represents the distance variation between the signal transceiver device 12 and the signal transmission device 14. Then, step 304 is executed to utilize the processing unit 24 to analyze the reacting signal S2, so as to calculate the distance between the signal transceiver device 12 and the signal transmission device 14 according to the intensity of the reacting signal S2. As the detecting unit 22 receives the plurality of reacting signals S2, there are a lot of signal transceiver devices 12 disposed within the effective range of the detecting signal S1. The processing unit 24 can analyze the plurality of reacting signals S2 in sequence, to select the reacting signal S2 with great value, so as to find out the nearest signal transceiver device 12 for the automatically connection setting.

Step 306 is executed to utilize the processing unit 24 to compare the distance to the predetermined threshold. When the distance is greater than the threshold, the signal transmission device 14 does not search the suitable signal transceiver device 12, and then step 300 is executed to drive the detecting unit 22 to continuously output the detecting signal S1 for searching the suitable signal transceiver device 12. When the distance is smaller than the threshold, step 308 is executed that the processing unit 24 switches setting of the second wireless transmission unit 20 to output the control command for establishing the connection, so the second wireless transmission unit 20 can be automatically matched with the detected first wireless transmission unit 18. The present invention can effectively simplify operational procedures and connecting steps of matching the signal transmission device 14 with the signal transceiver device 12. As the signal transmission device 14 is the wireless mouse, steps 310 and 312 are executed to detect the coordinates of the signal transmission device 14, and to transmit the coordinates to the selected signal transceiver device 12 via the wireless transmission for executing the corresponding application program of the host.

Accordingly, the signal transceiver device 12 executes step 400 and 402 to receive the detecting signal S1 and then to generate the feedback reacting signal S2 according to the detecting signal S1. The actuating unit 16 can receive the detecting signal S1 and generate the reacting signal S2 actively or inactively according to property of the NFC functions. For example, the actuating unit 16 can be the conductive wire, which varies the electromagnetic flux due to the coupled electromagnetic fields. The actuating unit 16 can further be the reflective component for reflecting the electromagnetic signal or the optical signal. The actuating unit 16 can further be the electric wave follower, which can transmit the energy to the detecting unit 22 according to actuation of the detecting signal S1. Then, step 404 is executed to receive the control command form the signal transmission device 14 for confirming that the connection between the signal transmission device 14 and the signal transceiver device 12 is ready to establish. When the signal transmission device 14 is the wireless mouse, the signal transceiver device 12 can be the corresponding wireless signal transceiver. The signal transceiver device 12 can execute steps 406 and 408 to receive the coordinates outputted from the signal transmission device 14 via the wireless connection, and to transmit the coordinates to the host for driving the corresponding application program. In this embodiment, the signal transceiver device 12 is a relay of the coordinate transmission,

In conclusion, the protocol system of the present invention can provide a preferable connection switching method of matching the signal transceiver device with the signal transmission device that both have the wireless transmission function. The signal transmission device utilizes the NFC technology to search the signal transceiver device within the effective range, and determines that the holding signal transmission device is intend to control the selected signal transceiver device when the distance between devices is smaller than the predetermined threshold, so as to automatically switch the connection. Further, when the signal transmission device finds out the nearest signal transceiver device of the plurality of signal transceiver devices and the distance between the devices is smaller than the predetermined threshold, the signal transmission device is automatically matched with the selected signal transceiver device for the transmission connection. The signal transceiver device and the signal transmission device can respectively be the wireless signal transceiver (dongle) and the wireless mouse. When the wireless mouse moves from one host to the other host, the connecting setting of the wireless mouse is unnecessary to manually reset and the wireless signal transceiver is unnecessary to remove, the wireless mouse applied to the protocol system of the present invention can actively search the nearest wireless signal transceiver within the effective range for automatically switching the connection.

Comparing to the prior art, the present invention can simplify the conventional connecting procedures, which means the conventional method for switching the connection, such as a manual actuation or reset of the signal transmission device, is replaced by the present invention. Therefore, the protocol system of the present invention can automatically and rapidly switch the connection between the different devices, so as to increase the operational convenience and market competition of the product.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of automatically switching connection, the method being applied to connection setting between a signal transmission device and at least one signal transceiver device, the method comprising:
outputting a detecting signal to search the signal transceiver device within an effective range of the detecting signal;
receiving a reacting signal generated according to the detecting signal;
analyzing the reacting signal wherein the reacting signal represents a distance between the signal transmission device and the signal transceiver device; and
switching the connection setting of the signal transmission device when the distance is smaller than a threshold, so that the signal transmission device is matched with the signal transceiver device.

2. The method of claim 1, wherein the reacting signal is an optical signal, the signal transmission device analyzes a reflecting energy intensity of the optical signal to acquire the distance.

3. The method of claim 1, wherein the reacting signal is an electromagnetic flux, electromagnetic fields of the signal transmission device and the signal transceiver device are coupled when the distance is smaller than the threshold so as to vary the electromagnetic flux.

4. The method of claim 1, wherein the reacting signal is radiofrequency radiation,
a radiofrequency identification label of the signal transmission device outputs
a control command for setting connection when receiving the reacting signal with sufficient intensity.

5. The method of claim 4, further comprising:
receiving energy via the reacting signal; and
driving the radiofrequency identification label to output the control command by the energy.

6. The method of claim 4, further comprising:
the radiofrequency identification label actively outputting the control command when the distance is smaller than the threshold.

7. The method of claim 1, further comprising:
receiving a plurality of reacting signals;
analyzing the plurality of reacting signals; and
selecting the reacting signal with great value wherein the reacting signal represents a distance between the signal transmission device and the signal transceiver device corresponding to the selected reacting signal.

8. The method of claim 1, further comprising:
detecting coordinates of the signal transmission device; and
transmitting the coordinates to the signal transceiver device via the connection.

9. A method of automatically switching connection, the method being applied to connection setting of a signal transceiver device relative to a signal transmission device, the method comprising:
receiving a detecting signal;
outputting a reacting signal generated according to the detecting signal; and
receiving a control command to establish connection between the signal transmission device and the signal transceiver device.

10. The method of claim 9, further comprising:
receiving coordinates of the signal transmission device via the connection; and
transmitting the coordinates to a host.

11. A protocol system capable of automatically switching connection, the protocol system comprising:
at least one signal transceiver device, the signal transceiver device comprising:
an actuating unit for generating a reacting signal; and
a first wireless transmission unit; and
a signal transmission device, the signal transmission device comprising:
a second wireless transmission unit;
a detecting unit for outputting a detecting signal and receiving the reacting signal generated by the actuating unit according to the detecting signal; and
a processing unit electrically connected to the second wireless transmission unit and the detecting unit, the processing unit receiving and analyzing the reacting signal to acquire a distance between the signal transmission device and the signal transceiver device when the detecting signal detects the signal transceiver device, and switching connection setting of the second wireless transmission unit when the distance is smaller than a threshold, so that the first wireless transmission unit is matched with the second wireless transmission unit;
wherein the reacting signal represents the distance between the signal transmission device and the signal transceiver device.

12. The protocol system of claim 11, wherein the actuating unit of the signal transceiver device is a conductive wire, a reflective component with reflective property, or an electric wave follower.

13. The protocol system of claim 12, wherein the detecting signal is an optical signal, the reflective component reflects the optical signal to generate the reacting signal, and the processing unit analyzes a reflecting energy intensity of the reacting signal to acquire the distance.

14. The protocol system of claim 12, wherein the detecting unit and the actuating unit are the conductive wires, electromagnetic fields of the detecting unit and the actuating unit are coupled to vary electromagnetic flux of the reacting signal.

15. The protocol system of claim 12, wherein the detecting unit is a radiofrequency identification label, the radiofrequency identification label outputs a control command for setting connection when receiving the reacting signal with sufficient intensity.

16. The protocol system of claim 15, wherein the electric wave follower utilizes the reacting signal to transmit energy to the radiofrequency identification label, so as to drive the radiofrequency identification label to output the control command.

17. The protocol system of claim 15, wherein the radiofrequency identification label comprises a power source, the radiofrequency identification label utilizes the power source to actively output the control command.

18. The protocol system of claim 11, wherein the detecting unit acquires the distance according to an intensity of the reacting signal, and a value of the intensity is inversely proportional to the distance between the signal transmission device and the signal transceiver device substantially.

19. The protocol system of claim 11, wherein the protocol system further comprises a plurality of signal transceiver devices, when the detecting unit receives a plurality of reacting signals, the processing unit selects the reacting signal with great value so as to acquire the distance between the signal transmission device and the signal transceiver device corresponding to the selected reacting signal.

20. The protocol system of claim 11, wherein the signal transmission device further comprises a coordinate detecting unit electrically connected to the processing unit, the coordinate detecting unit detects coordinates of the signal transmission device, and the processing unit transmits the coordinates to the signal transceiver device via connection of the wireless transmission units.
